(19) United States
(12) Patent Application Publication
(10) Pub. No.: US 2003/0043110 A1
(43) Pub. Date: Mar. 6, 2003

(54) System and architecture of a personal mobile display

(75) Inventors: John Chaves, San Jose, CA (US); Glenn Perkins, San Jose, CA (US); Chuck Robinson, San Jose, CA (US)

Correspondence Address: PENINSULA IP GROUP, A Professional Law Corporation, 2290 North First Street, suite 101, San Jose, CA, 95131, US

(73) Assignee: AirSpeak

(21) Appl. No.: 09/946,965

(22) Filed: Sep. 4, 2001

(51) Int. Cl. G09G 5/00

(52) U.S. Cl. 345/156

(57) ABSTRACT

Disclosed herein is a personal mobile display that operate in collaboration with a host computer system that include a processor for executing PC compatible application programs capable of generating and displaying a plurality of operational functions and data in response to user specified input. The host system also includes a wireless data transceiver capable of communicating and exchanging application or system commands and data between the host computer and portable display tablet. The portable display tablet comprises a graphics display panel, a micro-controller, and a wireless transceiver to provide short-range communication between the host computer system and portable display tablet. The micro-controller of the portable display tablet executes a control program to process the commands and data received from the host computer via the wireless transceiver and provides the resultant application window, template, or graphical display data to the graphics display panel.

### BACKGROUND OF THE INVENTION

1. Field of the Invention

The present invention is generally related to mobile, interactive communications systems. More particularly, this invention relates to a personal computer access and communications system that permits immediate interactive access to and the use of an array of user-specified application programs on a corresponding host computer system through a wireless network.

2. Description of the Related Art

Computers are becoming increasingly powerful, lightweight, and portable. The computing power of computers that once filled entire rooms is now residing on a desktop. Laptop, notebook, and even smaller computers are practically as powerful as their desktop counterparts. Even smaller hand-held systems are capable of performing tasks that required a much larger system a few short years ago.

As a part of this trend, personal organizers or personal digital assistants (PDA) are becoming increasingly popular with a large segment of the population. Personal digital assistants tend to be small, lightweight, relatively inexpensive, and can perform such functions as keeping a calendar, an address book, a to-do list, etc. While many of these functions can also be provided in conventional computer systems, personal organizers are very well suited to the personal organization task due to their small size and portability.

As the demand for user-specified functionality via a wireless has increased substantially, a new class of systems has evolved to meet this demand. Often referred to as a thin client/server-networking environment, it has been driven by a substantial growth of wireless accessible resources including the Internet. This new form of portable computing device called a pen-based computer system. Initially, these systems only implemented a minimum number of functions including a thin network protocol, a network interface, a video display interface, some sort of input mechanism and just enough computational and memory resources to minimally support operation of a dedicated Web browser application.

More recently, pen-based display tablet systems have married the power of a general-purpose desktop computer with the functionality and reduced size of a personal digital assistant. The new form of pen-based display tablet system is slightly larger than a hand-held device, rectangular in shape, about the size of an eight and half by eleven-inch piece of paper and employs a “pen” or stylus as the primary input device. Typically, these systems include a flat panel touch display screen that functions as both an input and output device, a relatively high performance micro-controller or processor and sufficiently memory space to support both an embedded operating system as well as a set of pre-installed applications.

The touch screen display of the pen-based display tablet system permits users to operate the system as a computerized notepad, for example. Graphic images are input to the pen-based display tablet system by merely moving the stylus across the surface of the screen. As the pen-based display tablet system's micro-controller or processor senses the position and movement of the stylus, it generates a corresponding image on the screen, thus, creating the illusion that the stylus is drawing the image directly upon the screen. When the stylus crosses the surface of the screen a plurality of pixels are electronically excited in such a manner that it appears that the stylus is leaving a trail of “ink” on the display. With the appropriate application software, the movement of the stylus over the surface of the display is recognized as either text, numeric, or graphics input to the pen-based display tablet system, forming a user interactive subsystem that works like a user interface on a fully functional personal computer or other desktop system.

However, the problem with these systems is their inability to communicate effectively with other system, especially desktop computers that contain the applications and data that would be useful to a user of a pen-based display tablet system and personal digital assistants in a remote location. Such information might include, for example, email messages, accounting data or information contained in a word processor document. The exchange of application content and data between a pen-based display tablet and a desktop or host system has been only hindered by the inability to provide a simple but effective means for transferring and translating graphics, images and application content between systems.

### SUMMARY OF INVENTION

Thus, a general purpose of the present invention is to provide a mobile or free roaming microprocessor enabled display device suitable for use as a collaborative companion to a corporate user's desktop system. The personal mobile display serves as a remote display and remote command entry facility for a desktop system, with a wireless connection between the portable display device and the desktop system executing at least one application program, wherein the personal mobile display that comprises an integrated video display subsystem that allows a user to perform all commands that is normally performed by a full-function computer system including opening files, entering information and navigating through application window templates by means of moving a stylus across a touch sensitive display, a wireless transceiver configured to transmit and receive a data stream from at least one corresponding network-based computer system wherein the data stream includes both graphics, command functions and application content generated by a network-based desktop computer system executing ay least one application program and an on-board processing system that processes the incoming data stream containing command functions, graphics and application content received from a corresponding network-based computer system for display on the touch sensitive display, the on-board processing system also processes command function and user supplied input received from the touch sensitive display panel and transmits the command functions and user supplied input, through the wireless transceiver, to the corresponding network-based computer system.

This is achieved through the use of a personal mobile display that operates in collaboration with a host computer system that include a processor for executing PC compatible application programs capable of generating and displaying a plurality of operational functions and data in response to user specified input. The host system also includes a wireless data transceiver capable of communicating and exchanging application or system commands and data between the host computer and portable display tablet. The portable display tablet comprises a graphics display panel, a micro-controller, and a wireless transceiver to provide short-range communication between the host computer system and portable display tablet. The micro-controller of the portable display tablet executes a control program to process the commands and data received from the host computer via the wireless transceiver and provides the resultant application window, template, or graphical display data to the graphics display panel.

One advantage of the present invention is that the personal mobile display provides cost effective, wireless display to a user with the flexibility to interact with and operate applications on his or her desktop system without being tied to computer system at his or her desk without having to have the same capabilities and identical software as is resident on a conventioal computer system.

Another advantage of the present invention is that multiple personal mobile displays can be utilized in conjunction with a single network-based computer system to collaboratively provide access to applications executing on that computer system.

### BRIEF DESCRIPTION OF THE DRAWING:

For a further understanding of the objects and advantages of the present invention, reference should be had to the following detailed description, taken in conjunction with the accompanying drawing, in which like parts are given like reference numerals and wherein:

FIG. 1 is diagram illustrating a exemplary embodiment of the invention shown in a typical corporate-wide client/server-networking environment.

FIG. 2 is a diagram showing a cut away view exposing the essential operative elements of the personal mobile display in accordance with the present invention.

FIG. 3 is a block diagram detailing the operative components found on the on-board processing system in accordance with the present invention.

### DETAILED DESCRIPTION OF THE INVENTION

The present invention now will be described more fully with reference to the accompanying drawings, in which the preferred embodiments of the invention are shown. While the present invention is described as a single personal mobile display system corresponding a single corresponding host system on a typical local area environment, it should be appreciated by those skilled in the art the benefits and advantages of present invention is also applicable to a corporate-wide client/server environment. The present invention may, however, embodied in many different forms and should not be construed as limited to the embodiment set forth herein; rather these embodiments are provided so that this disclosure will be thorough and complete and will fully convey the invention to those skilled in the art.

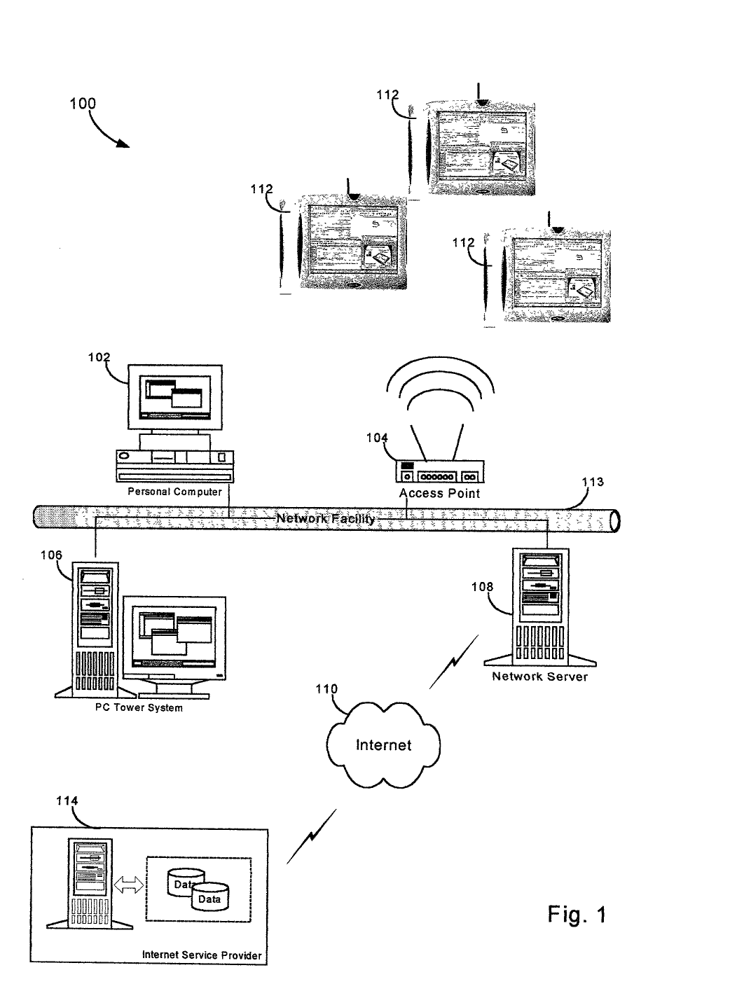

The invention will now be described with respect to FIG. 1, which illustrates the preferred embodiment of the invention shown in a corporate-wide client/server-networking environment 100. The computer network 100 includes several workstations or systems 102, 106 connected via a network facility 113, such as an Ethernet-based local area network, to a server 108. The host systems represented by PC workstation 102 and PC-based tower system 106 shown in FIG. 1, are Intel Pentium™, Microsoft Windows™ based platforms. Each system runs a plurality of commercially available applications as well as, in accordance with the present application, an interactive collaborative application that establishes a wireless communication channel via the network and the access point transceiver 104, to one or more of the personal mobile displays 112. The interactive collaborative application is not restricted to Intel Pentium ™ or Microsoft Windows™ based platforms but rather is capable of being implemented on any platform processor or operating system. In addition, the application programs executed by either the PC workstation 102 or PC-based tower system 106 are substantially without restriction in relationship to limitations imposed or potentially imposed by the present invention.

As illustrated in FIG. 1 an access-point transceivers 104 connects to the network 113. Typically, several access-point transceivers 104 will be strategically placed throughout a corporate facility. Each transceiver 104 acts as a bridge between the workstations or systems, represented by PC workstation 102 and PC-based tower system 106, connected to the network 100 and a corresponding personal mobile display 112. The access point transceivers 104 utilize the IEEE 802.11 (b) Ethernet standard for wireless networks and a corresponding TCP/IP protocol to communicate with the personal mobile displays 112 within a radius of several hundred feet and at speeds of between one to two megabits per second.

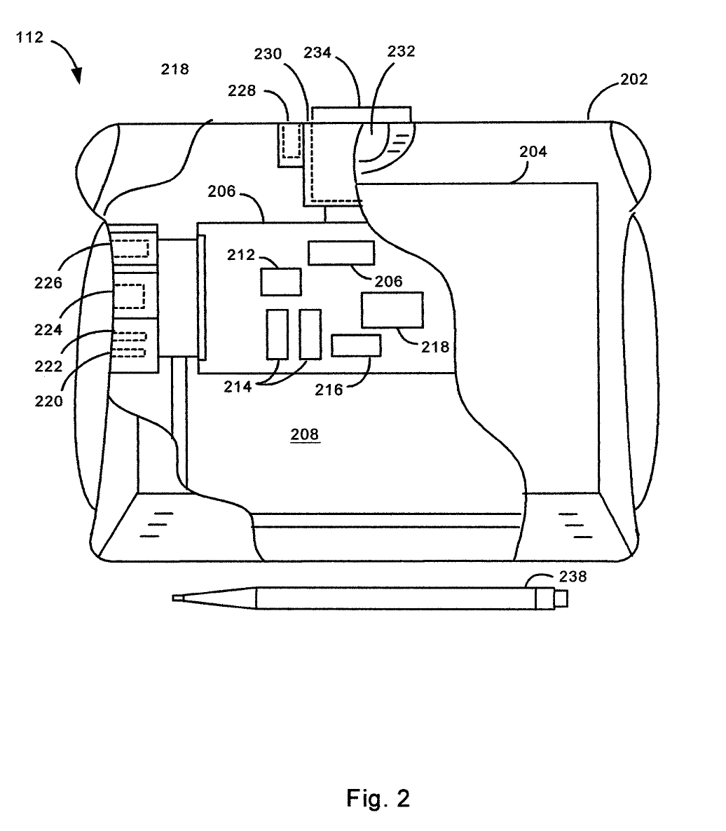

FIG. 2 is a diagram that illustrates a cut away view of the personal mobile display as implemented by the preferred embodiment of the present invention. The personal mobile display 112 is approximately ten by thirteen inches in size, weighing less than four pounds providing a user with the flexibility to interact with and operate his or her desktop system without being tied to his or her desk. As FIG. 2 shows an enclosure 202 that houses a touch sensitive display panel 202, a on-board processing system 206, a high capacity battery 208, a dual PCMCIA CARD slot 212 as well as an array of PC-oriented communications and I/O interfaces 210 -218. The touch sensitive display panel 202 can be either an active matrix liquid crystal display (LCD) or a dual-scan super-twist nematic display for rendering suitable color graphic images and application content at a resolution of 800 by 600 pixels or greater. The touch sensitive display panel 202 is lightweight and reasonably sturdy allowing a user to open files, enter information or navigate through application template or windows with the touch of a stylus 238.

The on-board processing system 206 includes an embedded 32-bit RISC-based microprocessor 210, a peripheral controller and co-processor 212, main memory 214 and FLASH memory 216. The main memory 214 is of sufficient size to execute the primary functions of an operating system such as Window CE™ as well as those application programs that are supplied with the personal mobile display. Here, the FLASH memory 216 is configured as a “solid state” disk that is designed to support most of the functional elements of the operating system. The peripheral controller and co-processor 212 is a companion processor to the embedded 32-bit RISC microprocessor 210. The peripheral controller and co-processor 212 provides support for a PS/2 keyboard/mouse interface (not shown) and audio CODEC, the PCMCIA slots 230, as well as a host USB port 216, a device USB port 218, a pair of audio ports 210, 212, and a standard VGA port 214. The motherboard 206 also includes integrated video display subsystem 218. The integrated video display subsystem 218 manages the operative functions of the touch sensitive display 204 as well as the functions that support a Windows™-like desktop and applications environment. Thus, from a user's prospective, the personal mobile display 112 is a wireless system that has the look and feel of a Windows™ based computer system that is not constrained by any potential compatibility issues as to type of processor or operating system running on a corresponding desktop system.

As shown in FIG. 2, the personal mobile display 112 is also configured with a dual PCMCIA slot 230. The dual PCMCIA card slot 212 as shown in outline illustrates its preferred position in back of a portion of the personal mobile display 112. The dual PCMCIA slot 230 is able to receive up to two the PCMCIA cards. A PCMCIA card 242 inserted in to one of the dual PCMCIA slots 230 adds desired functionality to the personal mobile display 112. One of the PCMCIA cards installed in the dual PCMCIA slot 230 is a wireless transceiver that allows the personal mobile display 112 to remotely communicate with a user's desktop system. Since the PCMCIA card 234 is shielded, there is very little, if any, electromagnetic interference between the electronics in the card and the components on the motherboard 206 or the touch sensitive display panel 202 mounted in the enclosure 202.

The flexibility and functionality of the personal mobile display 112 may be enhanced by the addition of a PCMCIA peripheral card 242. As conventional PCMCIA cards 242 are removable, the function or functions that can be added to the personal mobile display 112. For example, a PCMCIA card 44 having a cellular phone interface that allows the personal mobile display 112 to be operated at great distance from a host computer 102, 106 through a combination of air-links and land-lines that route to a host computer system 102, 106 in a conventional manner. A PCMCIA card 44 may also be a modem or other high-speed serial or parallel interface that can connect either directly to a host computer 102, 106 when the personal mobile display 112 is conveniently close to the host computer 102, 106 or remotely through any combination of air-links and land-lines. PCMCIA cards 44 may also be added to enhance the multimedia capabilities of the personal mobile display 112, add data communications capabilities including an Ethernet data connection or to upgrade the capabilities of the personal mobile display 112 in such areas as encryption or data compression.

As shown, the personal mobile display112 is power by a flat, thin line rechargeable battery pack 208 that can be accessed from a removable panel (not shown) on the back of the personal mobile display 112. While a high energy flat, thin line rechargeable battery pack 208 is used, the power requirements of the personal mobile display 112 are closely managed to minimize the load required to support the normal operation of the personal mobile display 112. The refresh rate and brightness of the touch sensitive display panel 204 may be reduced during periods of perceived inactivity. Also subsystems such as the dual PCMCIA slot 230, the touch sensitive display panel 204, as well as several of the other I/O functions can be selectively powered down when their use is not needed or desired. As a result, the personal mobile display 112 will have a battery life of approximately four hours.

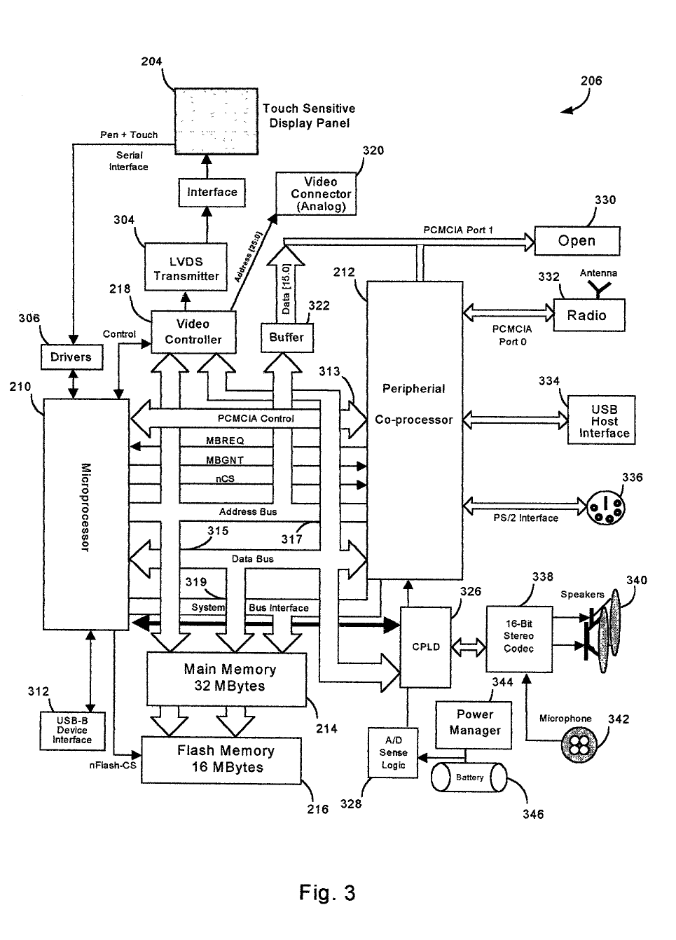

Reference is now made to FIG. 3 that is a block diagram detailing the operative components found on the on-board processing system as implemented by the present invention. As FIG. 3 illustrates the on-board processing system includes an embedded microprocessor 210, a peripheral controller and co-processor 212, thirty-two megabytes of SDRAM main memory 214 and sixteen megabytes of FLASH memory 216. The embedded microprocessor 210 is a general purpose, 32-bit RISC processor running at approximately 206 MHz. The internal architecture of embedded 32-bit RISC microprocessor 210 includes a sixteen kilobytes instruction, eight kilobytes write-back data cache, memory-management unit (MMU), a set of read and write buffers and is software compatible with the ARM V4 specification. The embedded microprocessor 210, in accordance with the present invention, accesses thirty-two megabytes of main memory 214 and sixteen megabytes of FLASH memory 216 via a thirty-two bits wide high-speed data bus 315. In addition, the embedded microprocessor 210 provides system support logic for one or more serial communication ports, a number of I/O interfaces and the two PCMCIA slots 330, 332.

As FIG. 3 shows, the embedded microprocessor 210 is directly interfaced to the peripheral controller and co-processor 212 through a system bus interface 319. The peripheral controller and co-processor 212 is a highly integrated and low power companion processor to the embedded microprocessor 210. The peripheral controller and co-processor 212 provides controller support for a USB host interface 334, a PS/2 keyboard and or mouse and a sixteen bit audio CODEC 338 that drives a set of speakers 340 and a microphone 342. In addition, the peripheral controller and co-processor 212 provides the interface to directly drive or control PCMCIA port 0 332 and PCMCIA slot 1 330. The peripheral controller and co-processor 212 also provide full card detection and PCMCIA voltage control to support both 3.3V and 5 V PCMCIA cards. In response to commands from the embedded microprocessor 210, the peripheral controller and co-processor 212 directs all required functions of the wireless transceiver installed in PCMCIA Port 0 332 and any key I/O capabilities designed to be used by the personal mobile display 112 that might be installed in PCMCIA Port 1 330.

The integrated video display subsystem 218 is a single chip graphics engine with two on-board graphics controllers that share up to two megabytes of on-chip display memory. The two on-board graphics controllers of integrated video display subsystem 218 provides independent, simultaneous command and control for the touch sensitive or pen-based functions as well as the CRT or graphic display functions used to support the look and feel of a Window™-like desktop display. The integrated video display subsystem 218 retrieves image data from its on-board memory and passes it to either the video interface 320 or the Flat Panel Interface 302 or both for display, depending on application requirements. Typically, images stored in memory or those generated by a series of graphics operations such as area fill, block move, line draw, etc. are received and placed in the on-board memory by the integrated video display subsystem 218.

These operations or commands are then supplied to one or both of the on-board graphics controllers for processing. The on-board memory is 128 bits wide and provides enough bandwidth to support two separate and independent images to be displayed on the touch sensitive display 204, simultaneously.

A conventional power manager 344 provides for the regulation of power to the personal mobile display 112 from either an external power source (not shown) or the on-board battery 346. Power manager 344 preferably is programmable by the peripheral controller and co-processor 212 to selectively provide power to the individual and separate subsystems of the personal mobile display 112. The peripheral controller and co-processor 212 is therefore able to effectively manage power consumption of the personal mobile display 112 as a whole. Specifically, independent power regulation is provided to the 16 bit CODEC 338 and speakers subsystem 340, the dual PCMCIA slot 230, PS/2 Interface, and USB Host interface. Power may be regulated selectively for other components of the personal mobile display 112 where continued or excessive power consumption is unnecessary or undesirable.

While the foregoing detailed description has described several embodiments of the personal mobile display in accordance with this invention, it is to be understood that the above description is illustrative only and not limiting of the disclosed invention. The personal mobile display paradigm has been described. While the present invention has been described particularly with reference to those professionals that require access to specific applications such as accounting, projection management, and email on his or her desktop system, the use of the personal mobile display is not limited to such an environment. Thus, one or more users can have concurrent, independent and collaborative access to both business and industrial application from a network-based computer system. Furthermore, a personal mobile display consistent with the present invention is not restricted to operating with only a single host computer, rather, through conventional authentication schemes or procedures, selection of a particular host or set of host computers can be made to support the personal mobile display throughout an entire corporate campus.

In view of the above description of the preferred embodiments of the present invention, those of skill in the art will readily appreciate many modifications and variations of the disclosed embodiments. It is therefore to be understood that, within the scope of the appended claims, the invention may be practiced otherwise than as specifically described above.

What is claimed is:

1. A personal mobile display that operate in collaboration with a remote desktop computer system executing at least one application program, wherein the personal mobile display comprises:
an integrated video display subsystem that allows a user to perform all commands that is normally performed by a full-function computer system including opening files, entering information and navigating through application window templates by means of moving a stylus across a touch sensitive display;
a wireless transceiver configured to transmit and receive a data stream from at least one corresponding network-based computer system wherein the data stream includes both graphics, command functions and application content generated by a network-based desktop computer system executing ay least one application program; and
an on-board processing system that processes the incoming data stream containing command functions, graphics and application content received from a corresponding network-based computer system for display on the touch sensitive display, the on-board processing system also processes command function and user supplied input received from the touch sensitive display panel and transmits the command functions and user supplied input, through the wireless transceiver, to the corresponding network-based computer system.

2. The personal mobile display as recited in claim 1, wherein the personal mobile display communicates to a non-network-based, stand-alone computer system, via its wireless transceiver, allowing the user to perform all commands normally performed on the computer system by means of moving a stylus across a touch sensitive display.

3. The personal mobile display as recited in claim 1, wherein the on-board processing system executes an application program having operational functions that processes and directs the integrated video display subsystem to simultaneously display graphic and application content on the touch sensitive screen that corresponds to the graphic and application content displayed on the network based computer system.

4. The personal mobile display as recited in claim 1, wherein the video display subsystem supports a graphical user interface that presents the user with both graphics and applications content in a format substantiaaly the same as on a desktop system.

5. The personal mobile display as recited in claim 3, wherein the format of graphics and application content that is displayed on the touch sensitive display is determined by the application program executed on the corresponding network-based desktop computer system.

6. A personal mobile display that operate in collaboration with a remote desktop computer system executing an array of application programs, wherein the personal mobile display comprises:
a touch sensitive display panel;
a integrated video display subsystem that provides simultaneous command and control for a touch sensitive or pen-based functions as well as the graphic display functions of the touch sensitive panel;
on-board processing subsystem interfaced to the integrated video display subsystem and the wireless transceiver that processes an incoming data stream received from a corresponding remote computer system for display on the touch sensitive display, the on-board processing system also processes user supplied input and transmits the user supplied input, through the wireless transceiver, to the corresponding network-based computer system.
a wireless transceiver configured to exchange data with a corresponding network-based computer system within a specified distance of the corresponding network-based computer system, the data including command functions, graphics and application content sent from corresponding network-based computer system to the personal mobile display and user input data sent from the personal mobile display to corresponding network-based computer system; and
an potable enclosure having an front assembly and a back assembly that houses the on-board processing subsystem, the wireless transceiver, the integrated video display subsystem and the touch sensitive display wherein the front assembly has a rectangular opening to expose the touch sensitive display.

7. The personal mobile display as recited in claim 6, wherein the personal mobile display further comprises a dual PCMCIA slot and a plurality of I/O interface ports wherein the I/O interface ports include a host USB port, a device USB port, a pair of audio ports, and a VGA port for use with a standard video display.

8. The personal mobile display as recited in claim 6, wherein the on-board processing subsystem that includes an embedded microprocessor, a companion peripheral controller and co-processor, main memory, non-volatile memory.

9. The personal mobile display as recited in claim 8, wherein the embedded microprocessor of the on-board processing subsystem is a general purpose, 32-bit RISC processor.

10. The personal mobile display as recited in claim 8, wherein the companion peripheral controller and co-processor of the on-board processing subsystem is a companion processor interfaced to the embedded microprocessor through a system bus interface.

11. The personal mobile display as recited in claim 10, wherein the companion peripheral controller and co-processor of the on-board processing subsystem directs the functionality of the dual PCMCIA slots where a wireless transceiver installed in a first PCMCIA slot while a second PCMCIA slot is available for other key I/O capabilities designed that may be required by the personal mobile display.

12. The personal mobile display as recited in claim 7, wherein the dual PCMCIA slot supports both 3.3V and 5 V PCMCIA cards.

13. The personal mobile display as recited in claim 8, wherein the embedded processor of the on-board processing subsystem is able to access thirty-two megabytes of main memory and sixteen megabytes of non-volatile memory through a thirty-two bits wide high-speed bus.

14. The personal mobile display as recited in claim 13, wherein the main memory is thirty-two megabytes of SDRAM, thirty-two bits wide.

15. The personal mobile display as recited in claim 13, wherein the sixteen megabytes of non-volatile memory is FLASH memory, sixteen bits wide.

16. The personal mobile display as recited in claim 6, wherein the integrated video display subsystem includes a display and graphics controller that provide the operative functionality to the touch sensitive display allowing a user to open files, enter information and navigate through application window templates by means of moving a stylus across a touch sensitive display.

16. The personal mobile display as recited in claim 15, wherein the display and graphics controller provides the operative functionality to the touch sensitive display allowing graphic and application oriented content to have the look and feel of a Windows™-like desktop environment.

17. The personal mobile display as recited in claim 6, further comprises a power module that includes a system power supply unit, a at least one flat, thin line rechargeable battery pack, and power manager.

19. The personal mobile display as recited in claim 18 where the a system power supply unit of the power module includes a external power supply interface disposed at the top of the enclosure in said case operably attached to a system power supply unit, where the system power supply unit includes a power supply port coupled to the base power supply, and said base support port is aligned to said power supply interface disposed at the top of the enclosure.

20. The personal mobile display as recited in claim 18 where in the flat, thin line rechargeable battery pack is accessible through a removable panel in the back assembly of the personal mobile display and is rechargeable from an external power source that is operably connected to the through the power supply port of the a system power supply unit.

21. The personal mobile display as recited in claim 18, wherein said power manager measures the power level of the flat, thin line rechargeable battery pack and provides an audible alarm when the battery pack has obtained a an unacceptable operative power level.

22. A personal mobile display, comprising:
a touch sensitive display panel for presentation of a graphics and application content;
a pointer device for providing user input;
an on-board processing subsystem wherein on-board processing subsystem includes wherein the on-board processing subsystem includes an embedded microprocessor, a companion peripheral controller and co-processor, main memory, non-volatile memory, an integrated display and graphics controller and an embedded transceiver subsystem to exchange data with a corresponding network-based computer system and process the data that includes command functions, graphics and application content sent from corresponding network-based computer system to the personal mobile display and user input data sent from the personal mobile display to corresponding network-based computer system; and
an potable enclosure having an front assembly and a back assembly that houses the on-board processing subsystem, the wireless transceiver, the integrated video display subsystem and the touch sensitive display wherein the front assembly has a rectangular opening to expose the touch sensitive display.

23. The personal mobile display as recited in claim 22, wherein the embedded microprocessor of the on-board processing subsystem is a general purpose, 32-bit RISC processor.

24. The personal mobile display as recited in claim 22, wherein the companion peripheral controller and co-processor of the on-board processing subsystem is a companion processor interfaced to the embedded microprocessor through a system bus interface.

25. The personal mobile display as recited in claim 24, wherein the companion peripheral controller and co-processor of the on-board processing subsystem directs the functionality of the a wireless transceiver and other key I/O capabilities designed that may be required by the personal mobile display.

26. The personal mobile display as recited in claim 22, wherein the personal mobile display also includes a dual PCMCIA slot that supports both 3.3V and 5 V PCMCIA cards.

27. The personal mobile display as recited in claim 22, wherein the embedded processor of the on-board processing subsystem is able to access thirty-two megabytes of main memory and sixteen megabytes of non-volatile memory through a thirty-two bits wide high-speed bus.

28. The personal mobile display as recited in claim 22, wherein the main memory is thirty-two megabytes of SDRAM, thirty-two bits wide.

29. The personal mobile display as recited in claim 22, wherein the sixteen megabytes of non-volatile memory is FLASH memory, sixteen bits wide.

30. The personal mobile display as recited in claim 22, wherein the integrated display and graphics controller provide the operative functionality to the touch sensitive display allowing a user to open files, enter information and navigate through application window templates by means of moving a stylus across a touch sensitive display.

31. The personal mobile display as recited in claim 30, wherein the integrated display and graphics controller provides the operative functionality to the touch sensitive display allowing graphic and application oriented content to have the look and feel of a Windows™-like desktop environment.

32. The personal mobile display as recited in claim 22, further comprises a power module that includes a system power supply unit, a at least one flat, thin line rechargeable battery pack, and power manager.
